(19) United States
(12) Patent Application Publication
(10) Pub. No.: US 2020/0136835 A1
(43) Pub. Date: Apr. 30, 2020

(54) SHARING SECURE CONNECTION CONTEXT VIA A TRUSTED PROXY

(71) Applicant: Nokia Solutions and Networks Oy, Espoo (FI)

(72) Inventors: Mohammed Petiwala, Buffalo Grove, IL (US); Tarun Agarwal, Palatine, IL (US)

(21) Appl. No.: 16/626,439

(22) PCT Filed: Jun. 30, 2017
(86) PCT No.: PCT/US17/40279

§ 371 Date: Dec. 24, 2019

(51) Int. Cl. H04L 9/32; H04L 29/06; H04L 9/00; G06F 9/455

(52) U.S. Cl. CPC H04L 9/3263; G06F 9/45558; H04L 9/006; H04L 63/0823

(57) ABSTRACT

Various communication systems may benefit from secure sharing of information. For example, various wireless communication systems may benefit from the sharing of a secure connection context via a trusted proxy. A method can include generating by a virtual machine instance a private key. The method can also include generating by the virtual machine instance a certificate signing request. The certificate signing request can include a universally unique identifier of the virtual machine instance. The method can further include sending the certificate signing request to a certificate signing authority.

### BACKGROUND

### Field

Various communication systems may benefit from secure sharing of information. For example, various wireless communication systems may benefit from the sharing of a secure connection context via a trusted proxy.

### Description of the Related Art

An X.509 certificate is a high-security credential used to encrypt, sign and authenticate transmissions, files and other data. X.509 certificates enable secure SSL/TLS channels and authenticate SSL/TLS servers and sometimes clients.

Hardware that is used in telecom, where a secure connection across a network is a primary function, usually contains a unique Electronic ID (EID), private key, and public certificate (X.509) which are flashed in hardware at factory at the time of manufacture. These private key and public certificates can be self-signed (third party) or signed by a root certification authority (CA).

Virtual machines and virtual storage are not manufactured in a factory, but are created on the fly on a host cloud hardware. These virtual machines do not have a unique hardware identifier (ID). It is not possible to have factory installed (flashed) private keys and/or certificates in virtual machines. Since s/w can be replicated, hence the embedded private keys and/or certificates can be replicated hence cannot be used to uniquely identify a virtual machine.

FIG. 1 illustrates a multi-node system. As shown in FIG. 1, Node-1 is a trusted cloud host hardware manufactured by Vendor-1. As part of the manufacturing of the host hardware, Node-1 is flashed with private key V1-PK1 and public cert V1-PC1 signed by vendor-1 CA (V1-CA). This hardware runs hypervisor which instantiates a virtual machine, namely Node-2.

Node-2 is virtual machine (VM) which is instantiated and miming on Node-1. Applications miming inside the VM are provided by Vendor-2. Vendor-2 is typically different from Vendor-1. The applications need to establish a secured connection with node 3, which is a server. To establish a secure connection, the application requires access to vendor-3 root CA (V3-CA) and a public cert signed by V3-CA. Server, Node-3, allows a secured connection to peers/clients only via Vendor-3 (V3-CA) signed and issued public certs. Since the applications running in virtual machine Node-2 do not have a unique EID, Vendor-3 cannot issue V3-CA signed public certs for Node-2.

Node-3, server, is a secured server operated by Vendor-3 that provides service to secured clients, for example Node-4a, Node-4b, and the like. An example of such a server is citizens broadband radio service (CBRS) spectrum access system (SAS). Refer to CBRS/WINNF documents for more details of SAS. Vendor-3 issues private keys and public certificates for secured clients signed by its root CA (V3-CA) for, for example, V3-PK4a/V3-PC4a, V3-PK4b/V3-PC4b, and the like.

Node-4a includes hardware and a software (s/w) application, such as citizens broadband service device (CBSD)+evolved node B (eNB). Node-4a hardware is manufactured by Vendor-2. The secured signed software running on Node-4a is also provided by Vendor-2. As part of the factory manufacturing procedure, Node-4a hardware is flashed with End-Entity (EE) private key (V2-PK4a), EE public certificate (V2-PC4a) with the common name (CN) in the certificate subject field specifying the unique EID of Node-4a. In addition, Vendor-1 root CA (V1-CA) is pre-loaded in the trusted authority (TA) database of Node-4a. Moreover, as part of the manufacturing procedure, Node-4a is loaded with the 2nd EE certificate/key pair private key (V3-PK4a), public cert (V3-PC4a) and root CA (V3-CA), issued by vendor-3. The Node-4a s/w can establish a secured connection with server Node-3 using V3-PK4a, V3-PC4a and V3-CA.

Node-4b includes hardware and a s/w application, for example CBSD+eNB. Node-4b hardware is manufactured by Vendor-2. The secured signed software running on Node-4b is also provided by Vendor-2. As part of the factory manufacturing procedure, Node-4b hardware is flashed with End-Entity (EE) private key (V2-PK4b), EE public certificate (V2-PC4b) with the CN specifying the unique EID of Node-4b. In addition, Vendor-1 root CA (V1-CA) is pre-loaded in the TA database of Node-4b. Moreover, as part of the manufacturing procedure Node-4b is loaded with the 2nd EE certificate/key pair private key (V3-PK4b), public cert (V3-PC4b) and root CA (V3-CA), issued by vendor-3. The Node-4b s/w can establish secured connection with server Node-3 using V3-PK4b, V3-PC4b and V3-CA.

### SUMMARY

According to certain embodiments, a method can include generating by a virtual machine instance a private key. The method can also include generating by the virtual machine instance a certificate signing request. The certificate signing request can include a universally unique identifier of the virtual machine instance. The method can further include sending the certificate signing request to a certificate signing authority.

In certain embodiments, a method can include mutually authenticating a node to a remotely hosted virtual machine instance. The method can also include authenticating the node to a server. The method can further include generating session key for the virtual machine instance. The method can additionally include providing the session key to the server.

An apparatus, according to certain embodiments, can include at least one processor and at least one memory including computer program code. The at least one memory and the computer program code can be configured to, with the at least one processor, cause the apparatus at least to generate by a virtual machine instance a private key. The at least one memory and the computer program code can also be configured to, with the at least one processor, cause the apparatus at least to generate by the virtual machine instance a certificate signing request. The certificate signing request can include a universally unique identifier of the virtual machine instance. The at least one memory and the computer program code can be further configured to, with the at least one processor, cause the apparatus at least to send the certificate signing request to a certificate signing authority.

An apparatus, in certain embodiments, can include at least one processor and at least one memory including computer program code. The at least one memory and the computer program code can be configured to, with the at least one processor, cause the apparatus at least to mutually authenticate a node to a remotely hosted virtual machine instance. The at least one memory and the computer program code can also be configured to, with the at least one processor, cause the apparatus at least to authenticate the node to a server. The at least one memory and the computer program code can further be configured to, with the at least one processor, cause the apparatus at least to generate session key for the virtual machine instance. The at least one memory and the computer program code can additionally be configured to, with the at least one processor, cause the apparatus at least to provide the session key to the server.

A computer program product can, in certain embodiments, encode instructions for performing a process, The process can include any of the above-mentioned methods.

A non-transitory computer readable medium can, according to certain embodiments, be encoded with instructions that, when executed in hardware, perform a process. The process can include any of the above-mentioned methods.

According to certain embodiments, an apparatus can include means for generating by a virtual machine instance a private key. The apparatus can also include means for generating by the virtual machine instance a certificate signing request. The certificate signing request can include a universally unique identifier of the virtual machine instance. The apparatus can further include means for sending the certificate signing request to a certificate signing authority.

In certain embodiments, an apparatus can include means for mutually authenticating a node to a remotely hosted virtual machine instance. The apparatus can also include means for authenticating the node to a server. The apparatus can further include means for generating session key for the virtual machine instance. The apparatus can additionally include means for providing the session key to the server.

### BRIEF DESCRIPTION OF THE DRAWINGS

For proper understanding of the invention, reference should be made to the accompanying drawings, wherein:

FIG. 1 illustrates a multi-node system.

FIG. 2 illustrates a multi-node system according to certain embodiments.

FIG. 3 illustrates a method according to certain embodiments.

FIG. 4 illustrates a further method according to certain embodiments.

FIG. 5 illustrates a system according to certain embodiments.

FIG. 6 illustrates a memory according to certain embodiments.

### DETAILED DESCRIPTION

Certain embodiments relate to a third party certificate based secure communication where one endpoint of the secured connection resides on virtual machine running on a cloud. More particularly, certain embodiments relate to citizen band radio service (CBRS) specified by the wireless innovation forum (WINNF). The CBRS system can use a secured connection based on transport layer security (TLS) and third party certificates.

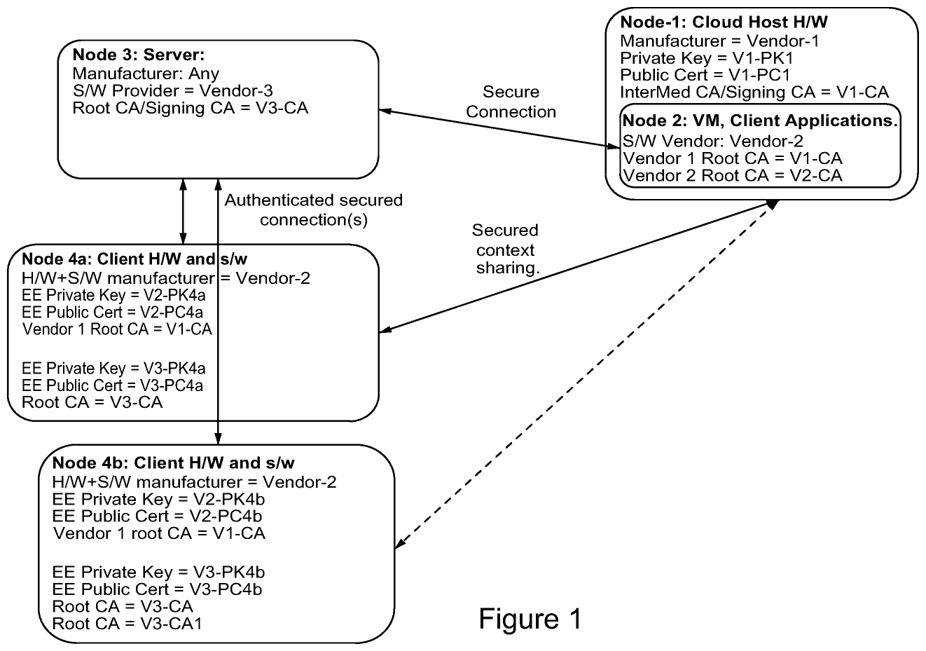

In the example shown in FIG. 1, a software application from Vendor-2 may need to establish a secure connection with server Node-3 but may be unable to do so, for the following five reasons. First, Vendor-1 and Vendor-3 are two different vendors and typically vendors do not mutually trust each other. Hence, V3-PK* and V3-PC* cannot be flashed into Node-1 hardware.

Second, Node-2 is a dynamically instantiated virtual machine (VM) image executing in software and cannot conventionally be tied with a unique endpoint identifier (EID). Hence, Node-2 cannot conventionally be pre-loaded or securely flashed with V3-PK*/V3-PC*. Third, due to the absence of unique EID and lack of hardware-based secure flashing procedure, Vendor-3 will not issue V3-PK*/V3-PC* for Node-2 VM instance.

Fourth, due to the second and third issues above, Node-2 does not have access to V3-PK* and V3-PC*. Fifth, due to the fourth issue, Node-3 will not be able to establish trust with Node-2. Hence, Node-2 cannot establish secure connection with Node-3.

Certain embodiments, by contrast, allow the establishment of a secure connection between application running inside virtual machine Node-2 and server Node-3. Moreover, certain embodiments can solve the connection problems described above.

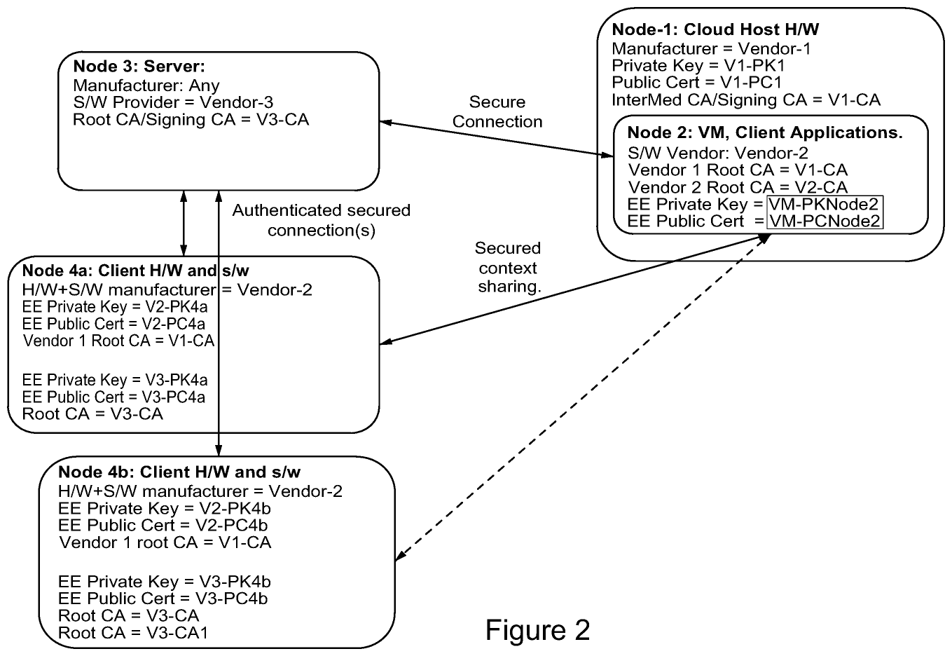

FIG. 2 illustrates a multi-node system according to certain embodiments. As shown in FIG. 2, Node-1 h/w can be flashed with Vendor-1 private key V1-PK1, public cert V1-PC1 signed/issued by Vendor-1 CA (V1-CA).

Moreover, a Node-2 software image from Vendor-2 can be pre-loaded with the Vendor-2 root certificate (V2-CA) and Vendor-1 Root CA (V1-CA). During instantiation/orchestration of Node-2, the host/hypervisor Node-1 can pass its public certificate V1-PC1 to Node-2.

Node-2 as part of a boot process can validate V1-PC1 against the V1-CA. This way Node-2 can establish mutual trust with Node-1. Upon successfully completing this validation, Node-2 can generate a private key (VM-PKNode2) and certificate signing request (CSR) with the common name (CN)=UUID of its VM instance.

Node-2 can securely send the CSR to a hypervisor/cloud service, for example a meta-data server in cloud, to issue a signed certificate. Node-1 can sign the CSR with V1-CA and issue the certificate (VM-PCNode2) and can send the issued certificate back to Node-2.

Node-2 can now contain a private key (VM-PKNode2), a certificate (VM-PCNode2) that is signed/issued by Node-1 CA (V1-CA). Node-2's trust CA database can also contain V1-CA and V2-CA.

Node-2 and Node-4a can establish a secured connection by mutually authenticating each other using cert-key pairs (VM-PCNode2/VM-PKNode2) and (V3-PK4a/V3-PC4a) respectively. This secured connection can be initiated by either of the peer nodes Node-2 or Node-4a.

Next, Node-4a can establish a secured connection with Node-3 using the EE cert-key pair (V3-PC4a/V3-PK4a). Once the secured connection between Node-4a and Node-3 is established, Node-4a can create a random time-bound unidirectional session key (SKNode2) on behalf of Node-2 and can send the key to Node-3. Along with this key, Node-4a can also send additional information pertaining to Node-2, such as Node-2's universally unique identifier (UUID), Node-2's internet protocol (IP) address, and Node-2's Public Certificate (VM-PCNode2).

Once Node-3 receives this session key and information about Node-2, Node-3 can create a random time-bound unidirectional session key (SKNode3-2) to be used by Node-2. Node-3 can pass the session key down securely to Node-4a. Node-4a can proxy SKNode3-2 down to Node-2 using the secured connection established earlier.

At this point both the peers, Node-3 and Node-2, can contain time-bound unidirectional session keys that they can use to securely communicate and trust each other. Since these session keys, SKNode2 and SKNode3-2, are time-bound temporary keys they can be periodically refreshed, using the procedure described above.

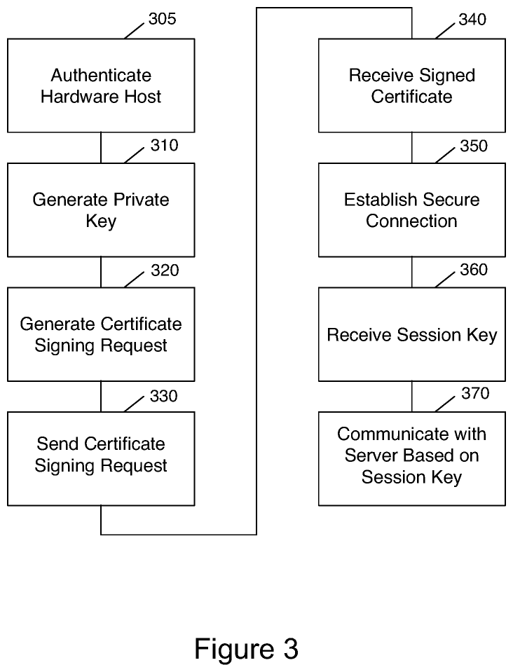

FIG. 3 illustrates a method according to certain embodiments. As shown in FIG. 3, a method can include, at 310, generating by a virtual machine instance a private key. The virtual machine instance may correspond to Node 2 in FIG. 2.

As shown in FIG. 3, the method can also include, at 320, generating by the virtual machine instance a certificate signing request. The certificate signing request can include a universally unique identifier of the virtual machine instance.

The method can further include, at 330, sending the certificate signing request to a certificate signing authority. This certificate signing authority may previously be authenticated to the virtual machine instance. For example, the method can also include, at 305, authenticating a hardware host of the virtual machine instance by the virtual machine instance based on a public certificate of the hardware host. The hardware host can be the certificate signing authority to provide the signed certificate, discussed above. Moreover this hardware host can correspond to Node 1 in FIG. 2.

As shown in FIG. 3, the method can further include, at 340, receiving, at the virtual machine instance, a signed certificate from the certificate signing authority. The method can additionally include, at 350, establishing a secure connection between the virtual machine instance and a remote node using the signed certificate. The remote node may be, for example, Node 4a or Node 4b in FIG. 2. Any other remote node may be similarly used, however.

As shown in FIG. 3, the method also include, at 360, receiving a session key for communication with a server from the remote node via the secure connection. The method can further include, at 370, communicating securely with the server based on the session key. The server may be, for example, Node 3 as shown in FIG. 2. Moreover, the method of FIG. 3 may be used in connection with the multi-node system of FIG. 2, in all of its example embodiments and options discussed above.

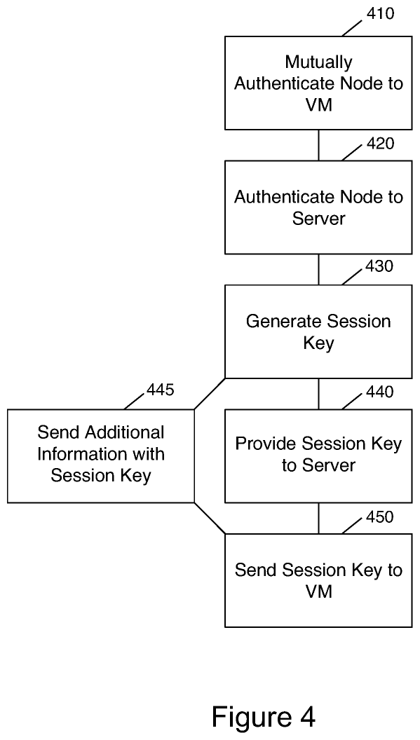

FIG. 4 illustrates a further method according to certain embodiments. The method of FIG. 4 is usable together with the method of FIG. 3 and with the multi-node system of FIG. 2, in all of its example embodiments and options discussed above.

As shown in FIG. 4, a method can include, at 410, mutually authenticating a node to a remotely hosted virtual machine instance, which can correspond to a part of the process of establishing the secure connection at 350 in FIG. 3. The node can be, for example, Node 4a or Node 4b in FIG. 2. The remotely hosted virtual machine instance can be, for example, Node 2 in FIG. 2.

As shown in FIG. 4, the method can also include, at 420, authenticating the node to a server. The method can further include, at 430, generating session key for the virtual machine instance. The method can additionally include, at 440, providing the session key to the server. The method can also include, at 445, sending with the session key additional information regarding the virtual machine instance. The additional information can include a universally unique identifier of the virtual machine instance, an internet protocol address of the virtual machine instance, and a public certificate of the virtual machine instance. The method can also include, at 450, sending the session key to the virtual machine instance. This can be the same session key received at 360 in FIG. 3.

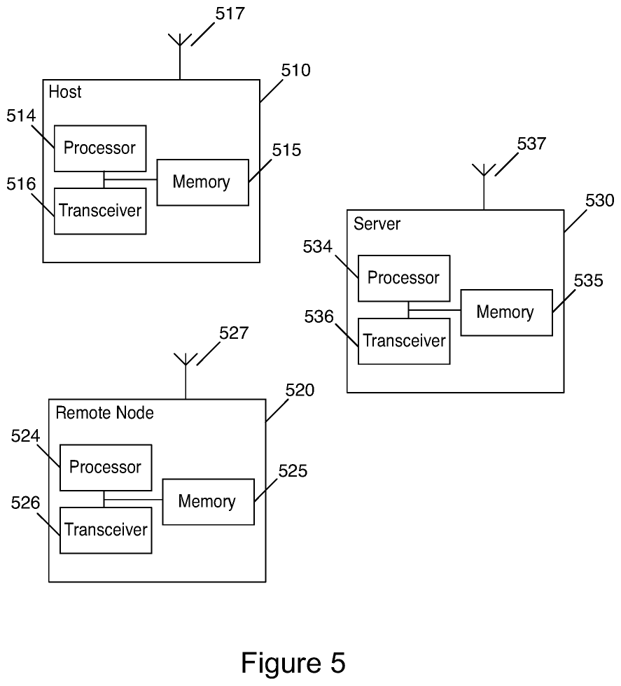

FIG. 5 illustrates a system according to certain embodiments of the invention. In one embodiment, a system may include multiple devices, such as, for example, at least one host 510, at least one remote node 520, and at least one server 530. Host 510 may correspond to Node 1 in FIG. 2 and may host one or more virtual machine instances, such as Node 2 in FIG. 2. Remote node 520 may be a separate physical device from host 510, but may be connected to host 510 through an internet connection, a wireless connection, or some other communication medium. Remote node 520 can correspond to Node 4a or Node 4b in FIG. 2. Server 530 may correspond to Node 3 in FIG. 2.

As shown in FIG. 5, each of the illustrated devices may include at least one processor, respectively indicated as 514, 524, and 534. At least one memory can be provided in each device, and indicated as 515, 525, and 535, respectively. The memory may include computer program instructions or computer code contained therein. The processors 514, 524, and 534 and memories 515, 525, and 535, or a subset thereof, can be configured to provide means corresponding to the various blocks of FIG. 3 or FIG. 4. The processors 514, 524, and 534 can be coupled or directly connected to memories 515, 525, and 535.

As shown in FIG. 5, transceivers 516, 526, and 536 can be provided, and each device may also include an antenna, respectively illustrated as 517, 527, and 537. Other configurations of these devices, for example, may be provided. For example, server 530 may be configured for wired communication, in addition to wireless communication, and in such a case antenna 537 can illustrate any form of communication hardware, without requiring a conventional antenna.

Transceivers 516, 526, and 536 can each, independently, be a transmitter, a receiver, or both a transmitter and a receiver, or a unit or device that is configured both for transmission and reception.

Processors 514, 524, and 534 can be embodied by any computational or data processing device, such as a central processing unit (CPU), application specific integrated circuit (ASIC), or comparable device. The processors can be implemented as, for example, a single controller, or, for another example, a plurality of controllers or processors. In certain embodiments, for further example, the processors can be implemented as a single core CPU or a multiple core CPU. In the case of a multiple core CPU, various steps may be taken by different cores, for example in parallel to one another. As mentioned above, the processors can each be coupled to ROM and RAM, in certain embodiments.

Memories 515, 525, and 535 can independently be any suitable storage device, such as a non-transitory computer-readable medium. A hard disk drive (HDD), random access memory (RAM), flash memory, or other suitable memory can be used. In certain embodiments, memories 515, 525, and 535 can include both RAM and read-only memory (ROM). The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

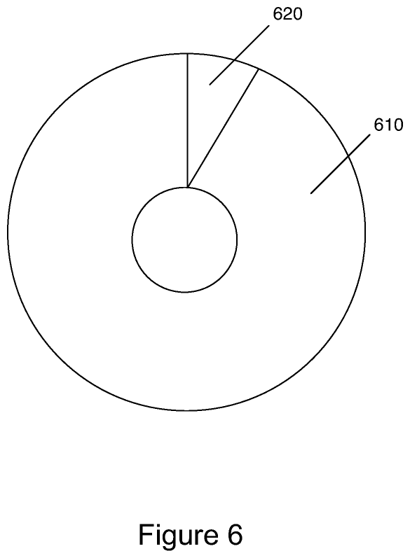

FIG. 6 illustrates a memory according to certain embodiments. The memory of FIG. 6 can be a pre-recorded disc 610 having computer program instructions 620 recorded thereon. The disc 610 may be, for example, a digital versatile disc (DVD), compact disc (CD), or any other desired storage medium. The computer program instructions may include instructions in any form, such as compiled code, machine code, or interpreted code.

Referring to FIG. 5, the memory and the computer program instructions can be configured, with the processor for the particular device, to cause a hardware apparatus such as host 510, remote node 520, and server 530, to perform any of the processes described herein (see, for example, FIG. 3 or FIG. 4). Therefore, in certain embodiments, a non-transitory computer-readable medium can be encoded with computer instructions that, when executed in hardware, perform a process such as one of the processes described herein. FIG. 6 provides an example of a non-transitory computer-readable medium can be encoded with computer instructions. The at least one host 510, at least one remote node 520, and at least one server 530 can each be an apparatus that can hold code and execute code. Alternatively, certain embodiments of the invention can be performed entirely in hardware.

Furthermore, although FIG. 5 illustrates a system including a host 510, remote node, and server, embodiments of the invention may be applicable to other configurations, and configurations involving additional elements. For example, not shown, additional network elements may be present, as illustrated in FIG. 2.

Certain embodiments may provide various benefits and/or advantages. For example, certain embodiments permit the sharing of an already established trust between two nodes (for example, Node-3 and Node-4a) to another trusted node (for example, Node-2). Various embodiments are also flexible. For example, in place of Node-4a in this discussion above, Node-4b or any other such node in the network can be used to establish trust and a secure connection between Node-2 and Node-3.

Moreover, an eNodeB can be provided as, for example, a cloud Flexi Zone Controller (cFZC) and flexi zone access points (FZ-APs) or as a Nokia Airframe expandable Base Station. The cFZC can be like Node 2 in the system described above and FZ-AP can be like Node-4a and Node-4b. There can be hundreds of FZ-APs connected to one cFZC. The cFZC can behave as domain proxy and FZ-APs will behave as CBSDs. The invention enables the implementation of cloud based domain proxy running on cFZC (Node-2) and CBSDs (Node-4a, Node-4b). Without this invention, there is no other way for cloud FZC to securely connect to a SAS server.

Certain embodiments may permit a citizens boadband radio service (CBRS) device (CBSD) or a CBRS domain proxy running within a VM on a third-party host cloud infrastructure to access a spectrum access system (SAS) server. Conventionally, there was no way for a CBSD or a CBRS domain proxy running within a VM to securely connect to a SAS server.

Moreover there may be situations an application within a VM running on third party cloud securely connects to a secure server, where the secure server has to uniquely identify the application with its serial number. This situation may also be enabled by certain embodiments of the present invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

CBRS Citizens Broadband Radio Service

CBSD Citizens Broadband Radio Service Device

SAS Spectrum Access System

cFZC Cloud Flexi Zone Controller

1-22. (canceled)

23. A method, comprising:
generating by a virtual machine instance a private key;
generating by the virtual machine instance a certificate signing request, wherein the certificate signing request comprises a universally unique identifier of the virtual machine instance; and
sending the certificate signing request to a certificate signing authority.

24. The method of claim 23, further comprising:
receiving, at the virtual machine instance, a signed certificate from the certificate signing authority.

25. The method of claim 24, further comprising:
establishing a secure connection between the virtual machine instance and a remote node using the signed certificate.

26. The method of claim 25, further comprising:
receiving a session key for communication with a server from the remote node via the secure connection.

27. The method of claim 26, further comprising:
communicating securely with the server based on the session key.

28. The method of any of claim 23, further comprising:
authenticating a hardware host of the virtual machine instance by the virtual machine instance based on a public certificate of the hardware host.

29. The method of claim 28, wherein the hardware host comprises the certificate signing authority to provide the signed certificate.

30. An apparatus, comprising:
at least one processor; and
at least one memory including computer program code,
wherein the at least one memory and the computer program code are configured to, with the at least one processor, cause the apparatus at least to
generate by a virtual machine instance a private key;
generate by the virtual machine instance a certificate signing request, wherein the certificate signing request comprises a universally unique identifier of the virtual machine instance; and
send the certificate signing request to a certificate signing authority.

31. The apparatus of claim 30, wherein the at least one memory and the computer program code are configured to, with the at least one processor, cause the apparatus at least to receive, at the virtual machine instance, a signed certificate from the certificate signing authority.

32. The apparatus of claim 31, wherein the at least one memory and the computer program code are configured to, with the at least one processor, cause the apparatus at least to establish a secure connection between the virtual machine instance and a remote node using the signed certificate.

33. The apparatus of claim 32, wherein the at least one memory and the computer program code are configured to, with the at least one processor, cause the apparatus at least to receive a session key for communication with a server from the remote node via the secure connection.

34. The apparatus of claim 33, wherein the at least one memory and the computer program code are configured to, with the at least one processor, cause the apparatus at least to communicate securely with the server based on the session key.

35. The apparatus of claim 30, wherein the at least one memory and the computer program code are configured to, with the at least one processor, cause the apparatus at least to authenticate a hardware host of the virtual machine instance by the virtual machine instance based on a public certificate of the hardware host.

36. The apparatus of claim 35, wherein the hardware host comprises the certificate signing authority to provide the signed certificate.

37. An apparatus, comprising:
at least one processor; and
at least one memory including computer program code,
wherein the at least one memory and the computer program code are configured to, with the at least one processor, cause the apparatus at least to
mutually authenticate a node to a remotely hosted virtual machine instance;
authenticate the node to a server;
generate session key for the virtual machine instance; and
provide the session key to the server.

38. The apparatus of claim 37, wherein the at least one memory and the computer program code are configured to, with the at least one processor, cause the apparatus at least to send with the session key additional information regarding the virtual machine instance.

39. The apparatus of claim 38, wherein the additional information comprises a universally unique identifier of the virtual machine instance, an internet protocol address of the virtual machine instance, and a public certificate of the virtual machine instance.

40. A computer program product encoding instructions for performing a process, the process comprising the method according to claim 23.

41. A non-transitory computer readable medium encoded with instructions that, when executed in hardware, perform a process, the process comprising the method according to claim 23.
